(19) United States
(12) Patent Application Publication
(10) Pub. No.: US 2004/0085252 A1
(43) Pub. Date: May 6, 2004

(54) Structure of antenna

(75) Inventor: U-Lin Ju, Pan Chiao City (TW)

Correspondence Address: TROXELL LAW OFFICE PLLC, SUITE 1404, 5205 LEESBURG PIKE, FALLS CHURCH, VA, 22041, US

(73) Assignee: Benq Corporation

(21) Appl. No.: 10/684,675

(22) Filed: Oct. 15, 2003

(30) Foreign Application Priority Data
Nov. 5, 2002 (TW) 91217735

(51) Int. Cl. H01Q 1/36; H01Q 9/30

(52) U.S. Cl. 343/895; 343/900

(57) ABSTRACT

A structure of antenna is constructed by combination of a housing and a cover by means the ultrasonic welding process. The housing is a column structure and a plurality of long protruders are axially mounted on the outer surface of the housing. The cover is a hollow column structure having an opening at one end thereof and a plurality of long channels and weldlines are axially mounted on the inner surface of the cover, wherein an interference fit is formed between the long channels and the long protruders, and the weldlines are disposed in the interference region formed between the long channels and the long protruders.

### FIELD OF THE INVENTION

The present invention relates to a structure of antenna, more particularly, to a structure of antenna of which the housing and the cover are combined by ultrasonic welding.

### BACKGROUND OF THE INVENTION

With rapid progress of wireless communication technology, mobile communication products have become the mainstream of modern science and technology products. After combined with the wireless communication modules, these products can be connected to the internet, receive and send electronic mails, and get prompt information on news or stocks so as to achieve the functions of resource sharing and information transmitting. The wireless communication modules used in the common mobile communication products including a notebook computer, a cellular phone and a personal digital assistant (PDA) etc. can be antenna structures or wireless network card.

Please refer to FIG. 1, which is a schematic structural diagram of a conventional antenna structure of a mobile phone. The antenna structure 10 mounted at an appropriate location of the mobile phone includes a housing 12 and a cover 14, wherein the housing 12 is a column structure made of a hard plastic material such as polycarbonate (hereinafter referred to simply as PC) and a radio frequency (hereinafter referred to simply as RF) module (not shown) is installed therein. The RF module can be a monopole antenna or a spiral antenna. The cover 14 is hollow column structure with an opening 141 at one end thereof and is combined with the housing 12 so as to protect the RF module inside the housing from damage of external forces. Moreover, to ensure the quality of the antenna structure 10, the products should pass the tensile force test and the torque force test so that the cover 14 and the housing 12 are combined securely.

Referring to FIGS. 2A and 2B, the combination of the cover 14 and the housing 12 is accomplished by the ultrasonic welding process. An annular flange 121 is mounted on the outer surface of the upper portion of the housing 12, and a collar 122 is mounted on the outer surface of the lower portion of the housing 12. An annular recess 142 is mounted on the inner surface of the upper portion of the cover 14, and a looped weldline 143 is mounted on the inner surface of the lower portion of the cover 14. When the housing 12 is telescoped into the cover 14, the flange 121 is received in the recess 142, and the collar 122 of the housing 12 is pressed against the weldline 143 of the cover 14. An interference fit is formed between the collar 122 and the weldline 143. The cover 14 is made of a thermoplastic polyester elastomer (hereinafter referred to simply as TPEE) which is softer than the PC material. In the process of ultrasonic welding, the high speeding oscillation produced by the ultrasound raises the temperature in the interference region of the antenna structure 10 and melt the weldline 143 so as to have the weldline 143 combined with the collar 122 of the housing 12 as a whole. Hence, the conventional antenna structure 10 resists the external torque force and the external tensile force imposed on the antenna structure 10 mainly with the combination strength resulted from the fusing of the housing 12 and the cover 14 after the weldline 143 is melted.

However, the prior art still has lots of disadvantages, including:

1. After the antenna structure is processed with ultrasonic welding, the outer surface of the cover corresponding to the weldline 143 thereof would bulge, and thus the appearance thereof is affected.

2. The welded region of the weldline is too limited to provide the quality standard of much stronger combination.

3. As shown in FIG. 3, the design of the recess 142 of the cover 14 does not facilitate stripping a core 16. After the injection of the cover 14, the core 16 should be separated from the cover 14. An annular raised mold 161 is designed to be mounted at an appropriate position of the core 16 corresponding to the annular recess 142 so as to form the annular recess 142 on the inner surface of the upper portion of the cover 14. However, such a design causes a difficult strip of the core 16 and a compelling strip is needed, and the size precision of products will be affected.

### SUMMARY OF THE INVENTION

The primary objective of the present invention is to provide a structure of antenna so as to prevent the bulge when the housing and the cover are welded.

The second objective of the present invention is to provide a structure of antenna which has a longer weldline so as to increase the combination strength between the housing and the cover and to resist the external twist force and external tensile force.

The third objective of the present invention is to provide a structure of antenna of which the cover is designed in a manner of natural stripping so as to ensure the precision and reliability of products.

The structure of antenna disclosed in this invention includes a housing and a cover. The housing is a column structure and a RF module which can transmit wireless signal with the environment is mounted therein. A plurality of long protruders are axially mounted on the outer surface of the housing. The cover is a hollow column structure having an opening at one end thereof. A plurality of long channels and weldlines are axially mounted on the inner surface of the cover. An interference fit is formed between the long channels on the inner surface of the cover and the long protruders on the outer surface of the housing, and the weldlines are disposed in the interference region formed between the long channels and the long protruders. Furthermore, a stopper in stair shape is mounted on the inner surface of the upper portion of the cover, of which stopping faces can block the front end of the housing so as to restrict the inserting depth of the housing into the cover.

In assembling the antenna structure of this invention, the long channels on the inner surface of the cover firstly are aimed at the long protruders on the outer surface of the housing, and then the housing is telescoped into the cover until the front end of the housing is pushed against the stopping faces of the stopper. At this time, the weldlines are exactly in the interference region formed after the long protruders are telescoped into the long channels. After the housing is telescoped into the cover and the ultrasonic welding process is carried out, the weldlines is melted due to the high temperature and is fused and combined with the long protruders of the housing and the long channels of the cover in a piece.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic structural diagram of an antenna structure of a mobile phone in the prior art;

FIGS. 2A and 2B are schematic diagrams from a sectional view illustrating the combination of antenna structure in the prior art;

FIG. 3 is a schematic diagram illustrating the stripping of the cover in the prior art;

FIG. 4 is a schematic perspective diagram of a first embodiment of the antenna structure in accordance with this invention;

FIG. 5 is a schematic diagram from a sectional view illustrating the first embodiment of the antenna structure in accordance with this invention;

FIG. 6 is a schematic diagram from a sectional view illustrating the cover of the antenna structure in accordance with this invention; and

FIGS. 7A and 7B are schematic diagrams of a second embodiment of the antenna structure in accordance with this invention.

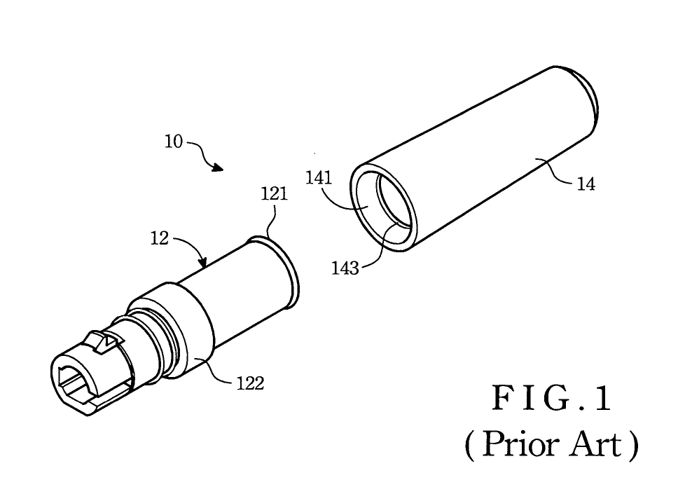

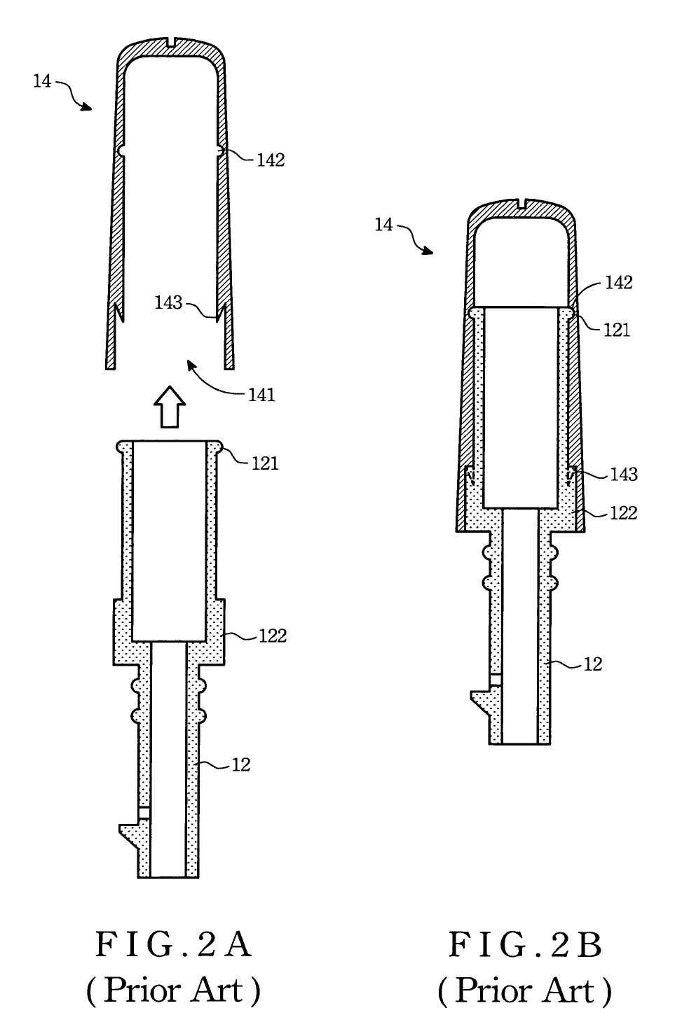

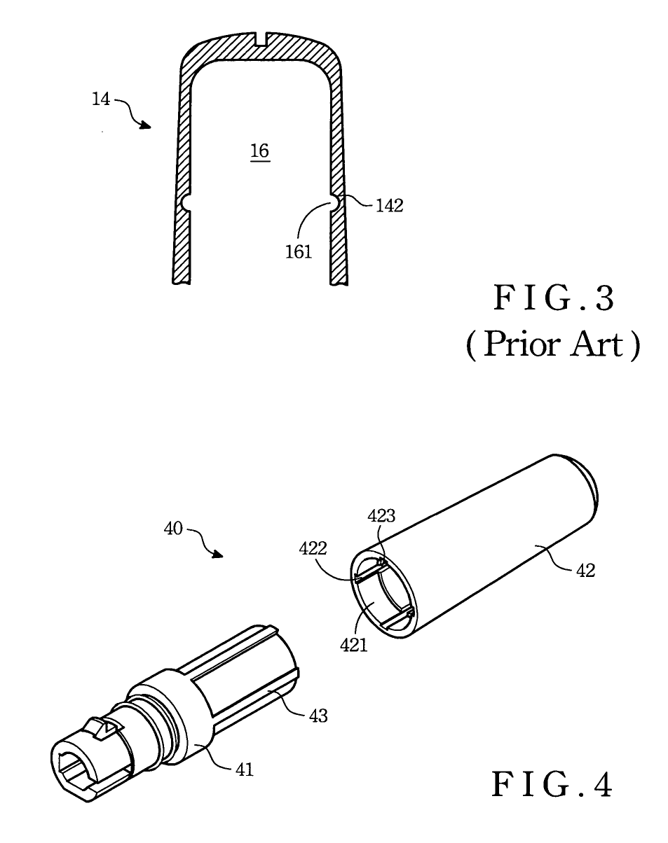

### DETAILED DESCRIPTION OF THE PREFERRED EMBODIMENT

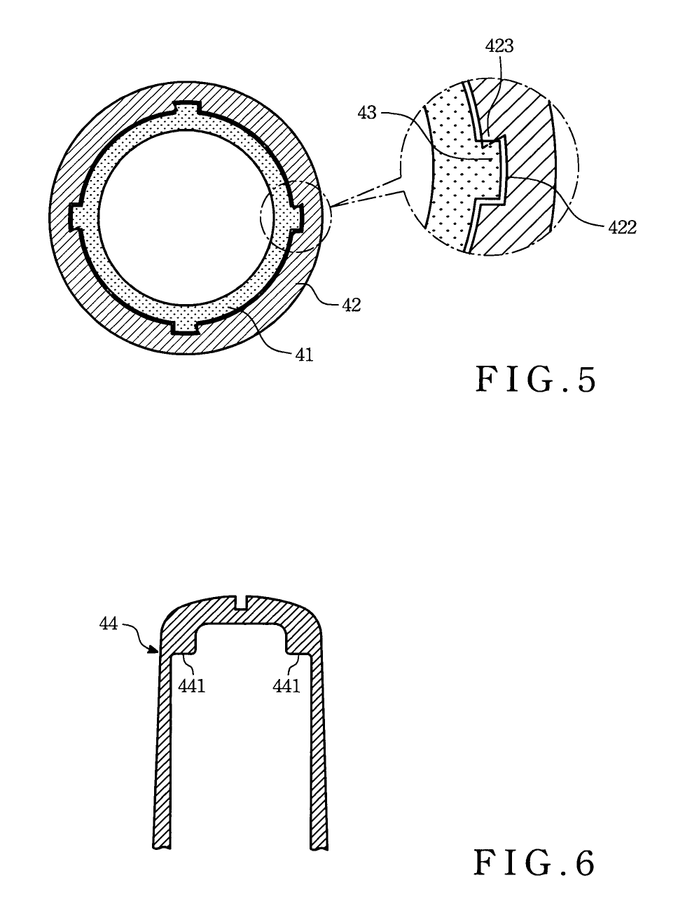

Please refer to FIG. 4, which is a schematic perspective diagram illustrating a first embodiment of the antenna structure in accordance with this invention. The antenna structure 40 includes a housing 41 and a cover 42, wherein the housing 41 is a column structure made of a PC material and a RF module (not shown) which can carry wireless signal transmission out with the environment is mounted therein. The RF module can be a monopole antenna or a spiral antenna. A plurality of long protruders 43 are axially mounted on the outer surface of the housing 41. In this embodiment, four long protruders 43 are equally axially mounted on the outer surface of the housing 41. The cover 42 is a hollow column structure, made of TPEE, having an opening 421 at one end thereof. A plurality of long channels 422 and long weldlines 423 are axially mounted on the inner surface of the cover 42. In FIG. 4, four long channels 422 along with the weldlines 423 are equally axially mounted on the outer surface of the housing 41. The housing 41 can be telescoped into the cover 42, wherein an interference fit is formed between the long channels 422 on the inner surface of the cover 42 and the long protruders 43 on the outer surface of the housing 41, and the weldlines 423 are disposed in the interference region (a shown in FIG. 5) formed between the long channels 422 and the long protruders 43. Furthermore, a stopper 44 in stair shape is mounted on the inner surface of the upper portion of the cover 42, of which stopping faces 441 can block the front end of the housing 41 so as to restrict the inserting depth of the housing 41 into the cover 42 (as shown in FIG. 6).

In assembling the antenna structure of this invention, the long channels 422 on the inner surface of the cover 42 firstly are aimed at the long protruders 43 on the outer surface of the housing 41, and then the housing 41 is telescoped into the cover 42 until the front end of the housing 41 is pushed against the stopping faces 441 of the stopper 44. At this time, the weldlines 423 are exactly in the interference region formed after the long protruders 43 are telescoped into the long channels 422. Since the TPEE material is softer than the PC material, the weldlines 423 in the interference region will be deformed and the TPEE material, especially the weldlines 423 in the interference region, will be melted in the high temperature after the ultrasonic welding. After the housing 41 is telescoped into the cover 42 and the ultrasonic welding process is carried out, the weldlines 423 is melted due to the high temperature and is fused and combined with the long protruders 43 of the housing 41 and the long channels 422 of the cover 42 in a piece.

In this invention, the strength from combination of the melted weldlines 423, the cover 42 and the housing 41 is used to resist the external tensile force and the external twist force. Hence, the longer is the weldlines 423, the stronger the combination strength of the cover and the housing. The number or the length of the channels 422 in this invention can be increased so as to increase the length of the weldlines 423 and further to enhance the combination strength of the cover and the housing. Therefore, comparing with the prior art, this invention can resist the larger external tensile force or twist force.

Furthermore, since the long protruders 43 in this invention are combined to the long channels 422 in a scarfing manner, a stronger strength is provided to resist the external twist force. In comparison with the prior art in which only the combination strength of the weldlines is used to resist the twist force, the capability to resist the external twist force in this invention is better.

In addition, the weldlines of this invention is equally axially distributed on the inner surface of the cover, and the spaced distance of the weldlines in the radial direction is larger and the extending space of the weldlines when melted is larger, and thus the outer surface of the cover is not liable to bulge. Hence, comparing with the prior art, the appearance of the antenna structure in this invention is pleasing.

Because the stopper in stair shape which facilitates a natural mold stripping is used to be mounted on the inner surface of the upper portion of the cover 42 in this invention, not only the fabrication of the core and the molding of a die are much easier, but also the core is readily separated from the cover during the mold stripping. Therefore, the precision and quality of manufacturing the cover can be ensured.

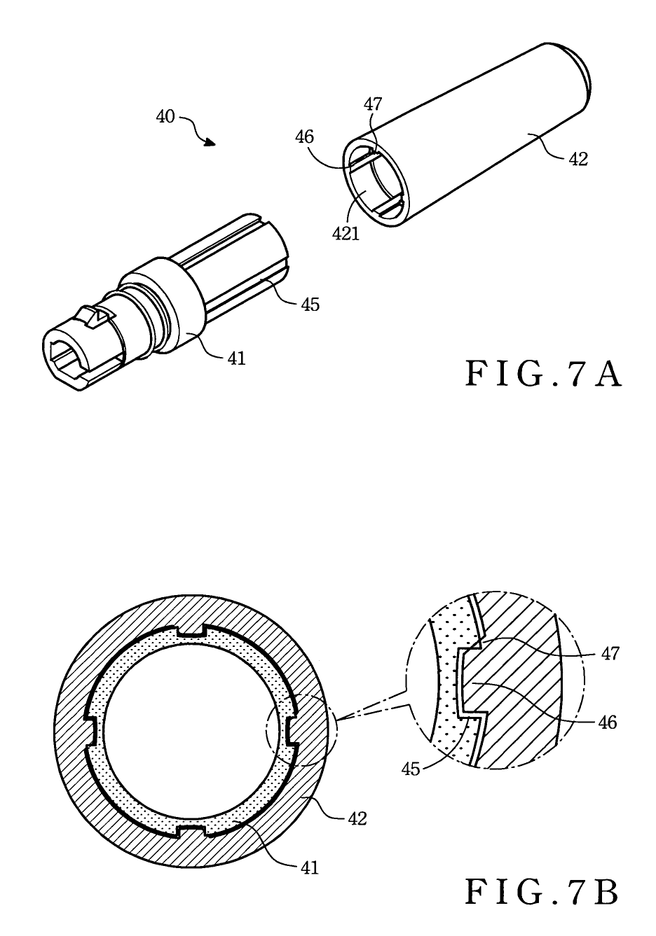

Referring to FIGS. 7A and 7B, which are schematic diagrams of a second embodiment of the antenna structure in accordance with this invention, the structure and embodied principle of this embodiment is substantially identical to those of the first embodiment, and the same elements are named with the same numerals and will not be reiterated.

The most difference between this embodiment and the first embodiment resides in that a plurality of long channels 45 are axially mounted on the outer surface of the housing 41 and simultaneously, a plurality of long protruders 46 and weldlines 47 are axially mounted on the inner surface of the cover 42, wherein an interference fit is formed between the long channels 45 and the long protruders 46, and the weldlines 47 are disposed in the interference region formed between the long channels 45 and the long protruders 46. As for the combination of the cover 42 and the housing 41 as well as the ultrasonic welding process in this embodiment are the same as those in the first embodiment, and thus will not be reiterated.

Furthermore, the housing and the cover of this invention are not limited to be column structures and may also be conical structures which facilitate the assembly of the housing and the cover as well as the stripping of the core from the cover.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed:

1. A structure of antenna, comprising:
a housing, which is a column structure and on the outer surface of which a plurality of long protruders are axially mounted; and
a cover, which is a hollow column structure having an opening at one end thereof and on the inner surface of which a plurality of long channels and weldlines are axially mounted, wherein an interference fit is formed between said long channels and said long protruders, and said weldlines are disposed in the interference region formed between said long channels and said long protruders.

2. The structure of antenna of claim 1, wherein a RF module is mounted in said housing.

3. The structure of antenna of claim 2, wherein said RF module is a monopole spiral antenna.

4. The structure of antenna of claim 1, wherein an ultrasonic welding process is used to melt said weldlines so that said long channels and said long protruders are fused to combine said housing and said cover.

5. The structure of antenna of claim 1, wherein said cover is made of a thermoplastic polyester elastomer, and said housing is made of polycarbonate material.

6. The structure of antenna of claim 1, wherein said long protruders are equally axially mounted on the outer surface of said housing, and said long channels are equally axially mounted on the inner surface of said cover.

7. The structure of antenna of claim 1, wherein a stopper in stair shape is mounted on the inner surface of the upper portion of said cover and blocks the front end of said housing so as to restrict the inserting depth of said housing into said cover.

8. The structure of antenna of claim 7, wherein said stopper of said cover is designed with a natural mold stripping.

9. A structure of antenna, comprising:
a housing, which is a column structure and on the outer surface of which a plurality of long channels are axially mounted; and
a cover, which is a hollow column structure having an opening at one end thereof and on the inner surface of which a plurality of long protruders and weldlines are axially mounted, wherein an interference fit is formed between said long channels and said long protruders, and said weldlines are disposed in the interference region formed between said long channels and said long protruders.

10. The structure of antenna of claim 9, wherein a RF module is mounted in said housing.

11. The structure of antenna of claim 10, wherein said RF module is a monopole spiral antenna.

12. The structure of antenna of claim 9, wherein an ultrasonic welding process is used to melt said weldlines so that said long channels and said long protruders are fused to combine said housing and said cover.

13. The structure of antenna of claim 9, wherein said cover is made of a thermoplastic polyester elastomer, and said housing is made of polycarbonate material.

14. The structure of antenna of claim 9, wherein said long channels are equally axially mounted on the outer surface of said housing, and said long protruders are equally axially mounted on the inner surface of said cover.

15. The structure of antenna of claim 9, wherein a stopper in stair shape is mounted on the inner surface of the upper portion of said cover and blocks the front end of said housing so as to restrict the inserting depth of said housing into said cover.

16. The structure of antenna of claim 15, wherein said stopper of said cover is designed with a natural mold stripping.
